(19) United States
(12) Patent Application Publication
(10) Pub. No.: US 2024/0109108 A1
(43) Pub. Date: Apr. 4, 2024

(54) APPARATUS AND METHOD FOR HANDLING HAZARDOUS MATERIALS

(71) Applicants: FIPAK Research And Development Company, Rowley, MA (US); Erlab D.F.S. S.A.S., Val de Reuil Cedex (FR)

(72) Inventors: Stephane Hauville, Byfield, MA (US); Antoine Hauville, La Londe (FR); Gilles Mahé, Val de Reuil Cedex (FR); Pascal Sidaner, Val de Reuil Cedex (FR); Cédric Herry, Val de Reuil Cedex (FR)

(21) Appl. No.: 18/376,742

(22) Filed: Oct. 4, 2023

Related U.S. Application Data
(60) Provisional application No. 63/413,094, filed on Oct. 4, 2022.

(51) Int. Cl. B08B 15/02

(52) U.S. Cl. CPC B08B 15/023

(57) ABSTRACT

Apparatus for effecting safe handling of biological and/or chemical materials, the apparatus comprising: a housing enclosing a workspace, wherein the housing comprises an opening for accessing the workspace; a sash mounted to the housing, the sash being configured to move between a closed position in which the sash covers the opening of the workspace and an open position in which the sash does not cover the opening of the workspace; a ventilation system disposed in the housing for drawing air out of the workspace; a motor for moving the sash between the open position and the closed position; an external power source for operating at least one of the ventilation system and the motor; and a secondary power source for operating at least one of the ventilation system and the motor when the external power source cannot deliver power to operate at least one of the ventilation system and the motor.

### REFERENCE TO PENDING PRIOR PATENT APPLICATION

This patent application claims benefit of pending prior U.S. Provisional Patent Application Ser. No. 63/413,094, filed Oct. 4, 2022 by Erlab D.F.S. S.A.S. for APPARATUS FOR HANDLING HAZARDOUS MATERIALS (Attorney's Docket No. FIPAK-34 PROV).

The above-identified patent application is hereby incorporated herein by reference.

### FIELD OF THE INVENTION

This invention relates to biological safety cabinets and chemical fume hoods in general, and more particularly to novel apparatus for handling hazardous materials including, but not limited to, biological materials and/or hazardous chemicals.

### BACKGROUND OF THE INVENTION

Safety cabinets and fume hoods are commonly used in biological and chemical laboratories in order to physically separate a human technician from hazardous materials and remove hazardous materials (e.g., noxious fumes) from the laboratory, either by filtering or by venting air removed from the safety cabinet or fume hood.

In essence, a safety cabinet (or fume hood) comprises an enclosed workspace which is accessible via a front opening that may be selectively opened or closed (e.g., by moving a sliding sash vertically upward or downward so as to open-up or close-off the front opening), such that a laboratory technician can manipulate hazardous biological and/or chemical materials safely within the workspace.

With many safety cabinets and fume hoods, the workspace is kept under negative air pressure, e.g., via a ventilation system that draws air up and out of the workspace enclosed by the safety cabinet, either to external ventilation out of the laboratory, or to a filtration system that returns filtered air to the laboratory. As a result of such a construction, exposure of a technician to the materials being manipulated in the workspace enclosed by the safety cabinet or fume hood is minimized when the technician accesses the workspace through an open sash (i.e., because the negative air pressure acts to retain hazardous air born materials within the workspace or ventilation system).

Safety cabinets and fume hoods typically comprise internal lighting (e.g., fluorescent lights) for lighting the workspace, and may include other elements for segregating the technician from the workspace. By way of example but not limitation, safety cabinets and fume hoods may comprise sashes that partially close access to the workspace (e.g., to provide enhanced protection when the technician is working with very volatile or dangerous materials in the workspace), “glove-box” type sashes for permitting a technician to be completely isolated by a barrier from the workspace (e.g., to provide enhanced protection when the technician is working with dangerous biological materials), etc. Sashes may be configured to open in a variety of different manners (e.g., slide up, slide down, slide horizontally, fold up, etc.) and, if desired, may be configured to open or close via an electronic motor.

However, it has been recognized that conventional safety cabinets and fume hoods suffer from several limitations.

First, it has been recognized that in the event of a power failure in the laboratory, electronic systems of a safety cabinet or fume hood will fail to function, leading to a potentially hazardous condition because lighting in the safety cabinet or fume hood will be extinguished at the same time that negative air pressure is compromised (e.g., due to power failure causing the safety cabinet or fume hood ventilation system to cease to function). This can create a hazard for the technician accessing the workspace and/or personnel in the vicinity of the safety cabinet or fume hood.

More particularly, it will be appreciated that in the event of a power failure in the laboratory, the ventilation system of the safety cabinet or fume hood will typically cease to function (i.e., because the fan requires electrical power in order to draw air out of the workspace enclosed by the safety cabinet or fume hood so as to generate negative air pressure inside the workspace). Thus, a laboratory power failure can create a potentially hazardous situation inside the laboratory containing the safety cabinet or fume hood. By way of example but not limitation, where a volatile chemical substance is disposed in the workspace of the safety cabinet or fume hood, fumes from the volatile chemical substance may build-up within the interior of the safety cabinet or fume hood due to the lack of negative air pressure in the workspace, creating a potentially hazardous situation.

Additionally, in the event of a power failure in the laboratory, the lighting inside the safety cabinet or fume hood will turn off during a power failure in the laboratory, creating a hazardous situation for a technician accessing the safety cabinet or fume hood. By way of example but not limitation, a technician accessing the workspace of the safety cabinet or fume hood during a power failure that causes the workspace to become dark (i.e., due to the failure of lights) may accidentally spill a volatile chemical in the workspace, or be unable to safely cap an open container disposed in the workspace, etc.

Second, it has been recognized that even where a sash is configured to open electronically (e.g., via an electric motor), the technician must typically actuate a control located on the safety cabinet (or fume hood) or on a control panel for the safety cabinet or fume hood. This can be difficult in instances where the technician is carrying equipment or samples to the safety cabinet or fume hood and does not have a free hand to initiate opening of the sash.

Third, it has been recognized that in certain instances, it is desirable to initiate immediate (i.e., emergency) decontamination of the workspace inside the safety cabinet (e.g., a biological safety cabinet). By way of example but not limitation, where a technician accidentally spills or otherwise exposes a dangerous biological material within the confines of the workspace, it may be desirable to immediately close the sash (i.e., to isolate the contamination) and immediately decontaminate the entire workspace. However, traditional biological safety cabinets do not include any means of decontamination, and thus a technician normally must decontaminate the workspace in a manual fashion.

Fourth, it has been recognized that cleaning the inside surface of the sash (i.e., the surface inside of the workspace) can be challenging because it requires a technician to reach under the sash while it is open and then reach backward to clean the interior surface of the sash.

Fifth, it has been recognized that it can be challenging to appreciate the improper positioning of the sash of a safety cabinet or fume hood (or other misuse of the safety cabinet or fume hood) from a distance and/or when the safety cabinet or fume hood is clustered with a plurality of other safety cabinets or fume hoods (e.g., in an academic setting, a large laboratory, etc.).

Sixth, it has been recognized that it would be beneficial if a safety cabinet or fume hood could automatically (e.g., autonomously) ascertain the chemicals/materials being introduced into the safety cabinet or fume hood through the sash or used in the workspace of the safety cabinet or fume hood so as to determine whether those chemicals/materials are appropriate for use with the particular safety cabinet or fume hood.

Thus there is a need for a new and improved safety cabinet or fume hood comprising (i) a back-up power source for powering essential functions of the safety cabinet or fume hood in the event of a laboratory power failure, (ii) apparatus for effecting the hands-free opening and closing of the sash of the safety cabinet or fume hood, (iii) apparatus configured to effect the automated decontamination of the workspace inside a safety cabinet (e.g., a biological safety cabinet) without requiring exposure of the technician to the workspace, (iv) a sash which can be rotated outboard so that the interior surface of the sash can be cleaned, (v) a visual indicator for indicating a status of a safety cabinet or fume hood and/or the position of the sash of the safety cabinet or fume hood, and (vi) a system for automatically determining whether chemicals/microorganisms/materials placed in a safety cabinet or fume hood are appropriate for use with the particular safety cabinet or fume hood.

### SUMMARY OF THE INVENTION

The present invention comprises the provision and use of a new and improved safety cabinet or fume hood comprising (i) a back-up power source for powering essential functions of the safety cabinet or fume hood in the event of a laboratory power failure, (ii) apparatus for effecting the hands-free opening and closing of the sash of the safety cabinet or fume hood, (iii) apparatus configured to effect the automated decontamination of the workspace inside a safety cabinet (e.g., a biological safety cabinet) without requiring exposure of the technician to the workspace, (iv) a sash which can be rotated outboard so that the interior surface of the sash can be cleaned, (v) a visual indicator for indicating a status of a safety cabinet or fume hood and/or the position of the sash of the safety cabinet or fume hood, and (vi) a system for automatically determining whether chemicals/microorganisms/materials placed in a safety cabinet or fume hood are appropriate for use with the particular safety cabinet or fume hood.

In one preferred form of the invention, there is provided apparatus for effecting safe handling of biological and/or chemical materials, the apparatus comprising:
a housing enclosing a workspace, wherein the housing comprises an opening for accessing the workspace;
a sash mounted to the housing, the sash being configured to move between a closed position in which the sash covers the opening of the workspace and an open position in which the sash does not cover the opening of the workspace;
a ventilation system disposed in the housing for drawing air out of the workspace;
a motor for moving the sash between the open position and the closed position;
an external power source for operating at least one of the ventilation system and the motor; and
a secondary power source for operating at least one of the ventilation system and the motor when the external power source cannot deliver power to operate at least one of the ventilation system and the motor.

In another preferred form of the invention, there is provided apparatus for effecting safe handling of biological and/or chemical materials, the apparatus comprising:
a housing enclosing a workspace, wherein the housing comprises an opening for accessing the workspace;
a sash mounted to the housing, the sash configured to move between a closed position in which the sash covers the opening of the workspace and an open position in which the sash does not cover the opening of the workspace;
a ventilation system disposed in the housing for drawing air out of the workspace;
a motor for moving the sash between the open position and the closed position; and
a command module configured to operate the motor for moving the sash.

In another preferred form of the invention, there is provided apparatus for effecting safe handling of biological and/or chemical materials, the apparatus comprising:
a housing enclosing a workspace, wherein the housing comprises an opening for accessing the workspace; and
a decontamination system configured to selectively emit a decontamination agent into the workspace so as to decontaminate the workspace, the decontamination system comprising:
   a reservoir comprising a decontamination agent; and
   a decontamination array fluidically connected to the reservoir, the decontamination array comprising at least one dispersion head configured to emit the decontamination agent into the workspace.

In another preferred form of the invention, there is provided apparatus for effecting safe handling of biological and/or chemical materials, the apparatus comprising:
a housing enclosing a workspace, wherein the housing comprises an opening for accessing the workspace;
a sash mounted to the housing, the sash being configured to move between a closed position in which the sash covers the opening and an open position in which the sash does not cover the opening;
at least one sensor for detecting the position of the sash relative to the opening; and
at least one visual indicator mounted to the housing;
wherein the at least one visual indicator is configured to emit a visual signal indicating the position of the sash.

In another preferred form of the invention, there is provided apparatus for effecting safe handling of biological and/or chemical materials, the apparatus comprising:
a housing enclosing a workspace, wherein the housing comprises an opening for accessing the workspace;
a sash mounted to the housing, the sash being configured to move between a closed position in which the sash covers the opening and an open position in which the sash does not cover the opening;
a least one camera mounted to the housing such that the at least one camera can obtain image data of at least one of the workspace and the opening; and
a computer, wherein the computer is configured to analyze image data obtained by the at least one camera in order to identify materials placed in the workspace.

In another preferred form of the invention, there is provided a method for effecting safe handling of biological and/or chemical materials, the method comprising:
providing apparatus comprising:
   a housing enclosing a workspace, wherein the housing comprises an opening for accessing the workspace;
   a sash mounted to the housing, the sash being configured to move between a closed position in which the sash covers the opening of the workspace and an open position in which the sash does not cover the opening of the workspace;
   a ventilation system disposed in the housing for drawing air out of the workspace;
   a motor for moving the sash between the open position and the closed position;
   an external power source for operating at least one of the ventilation system and the motor; and
   a secondary power source for operating at least one of the ventilation system and the motor when the external power source cannot deliver power to operate at least one of the ventilation system and the motor; and
using power from the secondary power source to power at least one of the ventilation system and the motor when the external power source cannot deliver power to operate at least one of the ventilation system and the motor.

In another preferred form of the invention, there is provided a method for effecting safe handling of biological and/or chemical materials, the method comprising:
providing apparatus comprising:
   a housing enclosing a workspace, wherein the housing comprises an opening for accessing the workspace;
   a sash mounted to the housing, the sash configured to move between a closed position in which the sash covers the opening of the workspace and an open position in which the sash does not cover the opening of the workspace;
   a ventilation system disposed in the housing for drawing air out of the workspace;
   a motor for moving the sash between the open position and the closed position; and
   a command module configured to operate the motor for moving the sash; and
using the command module to move the sash between the open position and the closed position.

In another preferred form of the invention, there is provided a method for effecting safe handling of biological and/or chemical materials, the method comprising:
providing apparatus comprising:
   a housing enclosing a workspace, wherein the housing comprises an opening for accessing the workspace; and
   a decontamination system configured to selectively emit a decontamination agent into the workspace so as to decontaminate the workspace, the decontamination system comprising:
      a reservoir comprising a decontamination agent; and
      a decontamination array fluidically connected to the reservoir, the decontamination array comprising at least one dispersion head configured to emit the decontamination agent into the workspace; and
emitting the decontamination agent into the workspace so as to decontaminate the workspace.

In another preferred form of the invention, there is provided a method for effecting safe handling of biological and/or chemical materials, the method comprising:
providing apparatus comprising:
   a housing enclosing a workspace, wherein the housing comprises an opening for accessing the workspace;
   a sash mounted to the housing, the sash being configured to move between a closed position in which the sash covers the opening and an open position in which the sash does not cover the opening;
   at least one sensor for detecting the position of the sash relative to the opening; and
   at least one visual indicator mounted to the housing;
   wherein the at least one visual indicator is configured to emit a visual signal indicating the position of the sash; and
emitting a visual signal to indicate the position of the sash.

In another preferred form of the invention, there is provided a method for effecting safe handling of biological and/or chemical materials, the method comprising:
providing apparatus comprising:
   a housing enclosing a workspace, wherein the housing comprises an opening for accessing the workspace;
   a sash mounted to the housing, the sash being configured to move between a closed position in which the sash covers the opening and an open position in which the sash does not cover the opening;
   a least one camera mounted to the housing such that the at least one camera can obtain image data of at least one of the workspace and the opening; and
   a computer, wherein the computer is configured to analyze image data obtained by the at least one camera in order to identify materials placed in the workspace; and
identifying materials placed in the workspace.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing a novel apparatus for handling hazardous materials formed in accordance with the present invention;

FIG. 2 is a schematic view showing further aspects of the ventilation bay of the novel apparatus of FIG. 1; and

FIGS. 3-5 are schematic views showing further aspects of the novel apparatus of FIG. 1.

### DETAILED DESCRIPTION OF THE PREFERRED EMBODIMENTS

The present invention comprises the provision and use of a new and improved safety cabinet or fume hood comprising (i) a back-up power source for powering essential functions of the safety cabinet or fume hood in the event of a laboratory power failure, (ii) apparatus for effecting the hands-free opening and closing of the sash of the safety cabinet or fume hood, (iii) apparatus configured to effect the automated decontamination of the workspace inside a safety cabinet (e.g., a biological safety cabinet) without requiring exposure of the technician to the workspace; (iv) a sash which can be rotated outboard so that the interior surface of the sash can be cleaned, (v) a visual indicator for indicating a status of a safety cabinet or fume hood or the position of the sash of the safety cabinet or fume hood, and (vi) a system for automatically determining whether chemicals/microorganisms/materials placed in a safety cabinet or fume hood are appropriate for use with the particular safety cabinet or fume hood.

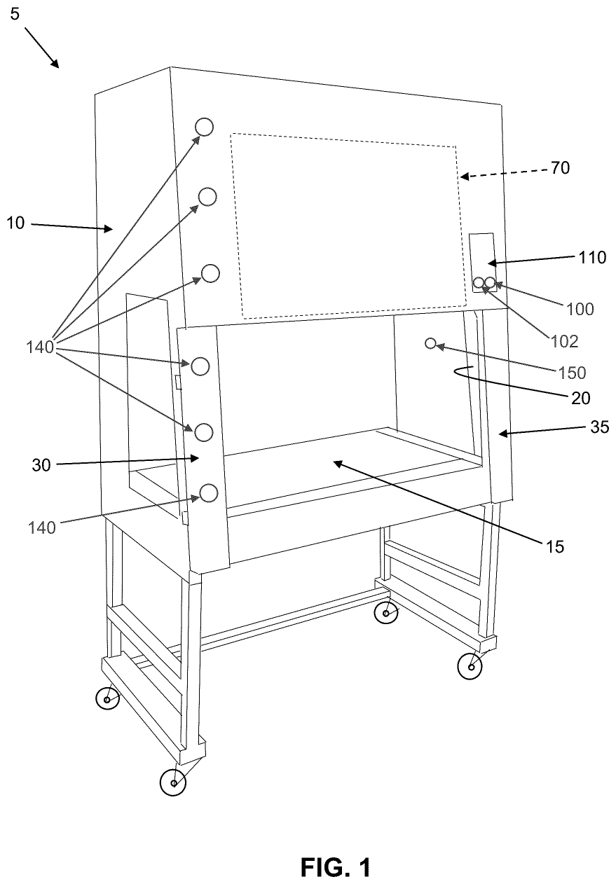

More particularly, and looking now at FIGS. 1-5, there is shown a novel safety cabinet 5 formed in accordance with the present invention. As used herein, the term “safety cabinet” is intended to refer to enclosed workspaces within which biological materials are handled (e.g., biological safety cabinets), as well as enclosed workspaces (e.g., chemical fume hoods) within which chemical agents are handled. Safety cabinet 5 generally comprises a housing 10 enclosing a workspace 15 and internal electronics, as will hereinafter be discussed in further detail.

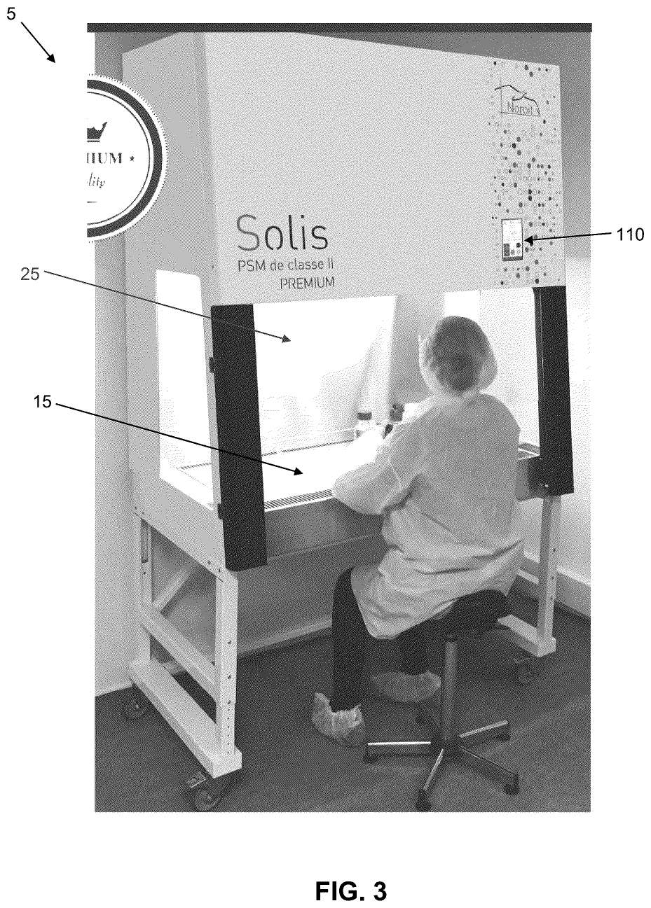

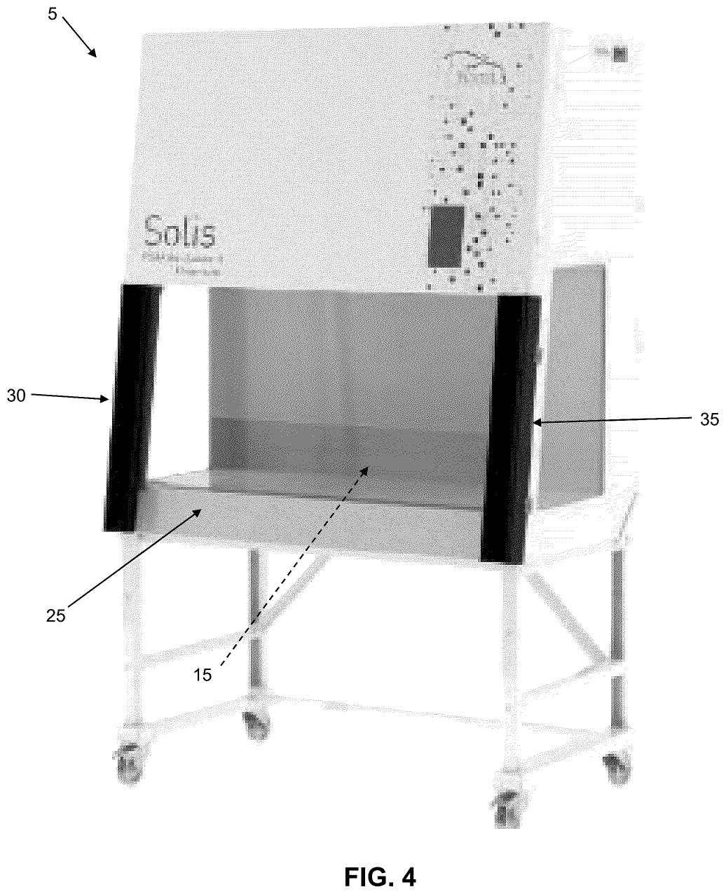

Housing 10 is formed so as to enclose workspace 15 on the bottom (i.e., a table surface for handling materials), the top (i.e., the area containing a ventilation system, lighting and electronics, as will hereinafter be discussed in further detail), and on three sides. Housing 10 comprises a front opening 20 where workspace 15 is not enclosed, so as to permit a technician to physically access workspace 15. A sash 25 (FIGS. 3 and 4) configured to slide vertically is disposed within housing 10 and configured to selectively close-off (or open-up) opening 20, whereby to fluidically seal workspace 15 relative to the ambient air of the laboratory when sash 25 is in its vertically-lowered closed-off position. When sash 25 is raised vertically upward into housing 10, opening 20 is opened-up, whereby to permit a technician to access workspace 15. It should be appreciated that sash 25 may be selectively disposed intermediate its fully “open-up” and fully “closed-off” positions, whereby to allow a technician to partially close off workspace 15 while still permitting some access to workspace 15. By way of example but not limitation, sash 25 may be vertically moved so as to close off the upper half of opening 20, whereby to afford extra protection to the head and eyes of a technician seated in front of opening 20, while still permitting the technician to physically access workspace 15 with their hands.

Sash 25 preferably comprises a transparent material (e.g., glass, plexiglass, etc.) for permitting a technician to view workspace 15 through sash 25 when sash 25 is in its closed position. In a preferred form of the invention, sash 25 is configured to move vertically relative to housing 10 via an electric motor that may be selectively actuated by a technician, as will hereinafter be discussed in further detail.

Novel Safety Cabinet 5 Comprising Back-Up Power

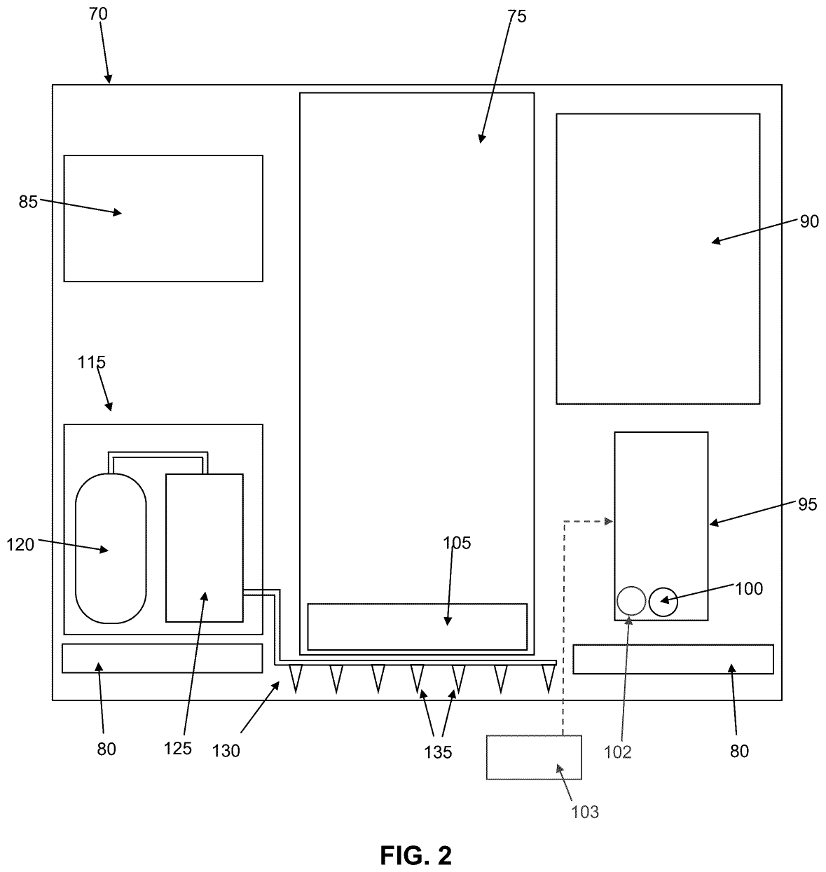

Looking still at FIG. 1, the upper portion of housing 10 encloses an electronics and ventilation bay 70. More particularly, and looking now at FIG. 2, electronics and ventilation bay 70 preferably comprises a ventilation system 75 (e.g., a fan and associated filtration system for removing air from workspace 15 and filtering or venting the removed air to the laboratory or to the environment), one or more lights 80 (e.g., LED and/or fluorescent lighting for lighting up workspace 15), at least one motor 85 configured to selectively move sash 25 up and down relative to housing 10 when actuated (whereby to selectively open-up or close-off opening 20), a back-up power source 90 (e.g., a battery backup), and a computer (e.g., CPU running appropriate software) 95 comprising a microphone 100, as will hereinafter be discussed in further detail.

Ventilation system 75 is preferably configured to maintain negative air pressure within workspace 15 by removing air from workspace 15 and directing the removed air through a filtration system (not shown) before returning the air to the laboratory (or to ambient air outside the structure containing the laboratory). To that end, ventilation system 75 generally comprises a fan 105 for moving air out of workspace 15, and one or more filters (not shown) for removing substances from air moved out of workspace 15 by fan 105.

In order to avoid a potentially hazardous situation resulting from power failure, in one preferred form of the invention, back-up power source 90 (e.g., a battery) is configured to provide emergency power to critical systems (e.g., ventilation system 75, lights 80, etc.) of safety cabinet 5 during a laboratory power failure. By way of example but not limitation, back-up power source 90 may be configured to provide an hour of light via lights 80 and/or ventilation of workspace 15 via ventilation system 75 so as to permit a laboratory technician to secure volatile chemicals inside safety cabinet 5 during a laboratory power failure.

### Hands-Free/Remote Operation Of Sash 25

It will also be appreciated that there are instances in which it may be desirable to automate the opening and closing of sash 25. By way of example but not limitation, in the situation in which a technician wishes to access workspace 15 via opening 20 and sash 25 is in its closed condition (i.e., so that opening 20 is closed off by sash 25), the technician may wish to move sash 25 vertically upward.

To this end, the at least one motor 85 of electronics and ventilation bay 70 of safety cabinet 5 is appropriately connected to sash 25 such that actuation of motor 85 causes sash 25 to move vertically (e.g., rotation of motor 85 in a first direction causes sash 25 to rise vertically so as to open opening 20 to permit access to workspace 15, and rotation of motor 85 in a second, opposite, direction causes sash 25 to lower vertically so as to close opening 20 to restrict access to workspace 15). In a preferred form of the invention, safety cabinet 5 comprises an external control panel 110 (FIG. 1) comprising one or more actuation buttons (or a touchscreen) for selectively actuating motor 85 in order to effect vertical movement of sash 25 relative to housing 10.

It will also be appreciated that in some situations, a technician may wish to operate motor 85 so as to move sash 25 in a desired manner without requiring the technician to use their hands to manipulate external control panel 110. By way of example but not limitation, a technician may be approaching safety cabinet 5 with their hands full (e.g., carrying a volatile chemical) and wish to open sash 25 without requiring the technician to physically contact external control panel 110. To this end, and looking at FIGS. 1 and 2, the aforementioned computer 95 is preferably configured (i.e., running appropriate software) to selectively actuate the at least one motor 85 in order to move sash 25 in a desired manner. Microphone 100 is connected to computer 95 (which is, in turn, running appropriate software), so as to permit verbal commands by the technician (e.g., “open the sash”, “close the sash”, etc.) to be relayed to computer 95, whereby to permit hands-free opening and closing of sash 25 by the technician. The use of verbal commands to control operation of sash 25 thus frees the technician's hands and enhances safety.

Alternatively and/or additionally, and still looking at FIGS. 1 and 2, if desired, an externally-directed camera 102 may be provided in order to permit hands-free opening and closing of sash 25 by a technician. More particularly, with this form of the invention, camera 102 is configured to monitor a field of view generally in front of sash 25 for the appearance of physical gestures by the technician. Computer 95 is appropriately configured (e.g., via software) to perform image analysis of image data received from camera 102, whereby to identify physical gestures (e.g., hand signals) and perform an appropriate action, as will be apparent to one of skill in the art in view of the present disclosure.

By way of example but not limitation, camera 102 may process an image of the technician in the field of view of camera 102 making an “0” symbol with their thumb and fingers, whereby to cause computer 95 to open sash 95. By way of further example but not limitation, camera 102 may process an image of the technician in the field of view of camera 102 crossing two fingers to make an “X”, whereby to cause computer 95 to close sash 95. Physical gestures may also be used to control other aspects of safety cabinet 5 (e.g., to activate lighting, fans, etc.).

Alternatively and/or additionally, if desired, a remote control 103 (FIG. 2) may be provided in order to permit remote operation of safety cabinet 5 (e.g., to selectively open or close sash 25). Remote control 103 may be provided in the form of a handheld wireless remote or, alternatively, as a wall-mounted hard-wired remote.

### Emergency Decontamination System

In the event of a spill of a hazardous biological substance or volatile chemical within workspace 15 of safety cabinet 5, it may be desirable to effect emergency decontamination of workspace 15. By way of example but not limitation, if a technician is working with a hazardous biological substance and accidentally spills the substance within workspace 15, the technician may wish to effect emergency decontamination of the interior workspace 15 of safety cabinet 5 so as to protect the laboratory from contamination.

To that end, and looking now at FIG. 2, safety cabinet 5 preferably comprises an emergency decontamination system 115. Sterilizing/neutralizing system 115 generally comprises a reservoir 120 comprising a pre-selected decontamination agent (e.g., hydrogen peroxide), a pump 125 (e.g., an electric pump) fluidically connected to reservoir 120, and a decontamination array 130 comprising one or more dispersion heads 135 fluidically connected to pump 125 which are configured to disperse the decontamination agent so as to fully decontaminate workspace 15. Although the one or more dispersion heads 135 are shown in FIG. 2 as being disposed in the lower portion of electronics and ventilation bay 70 (i.e., so as to be suspended above workspace 15 within housing 10 of safety cabinet 5), it will be appreciated that decontamination array 130 may extend about the interior of housing 10 enclosing workspace 15 in substantially any manner which will be apparent to one of ordinary skill in the art in view of the present disclosure.

### Novel Sash 25 Configured For Cleaning Interior Surface Of Sash 25

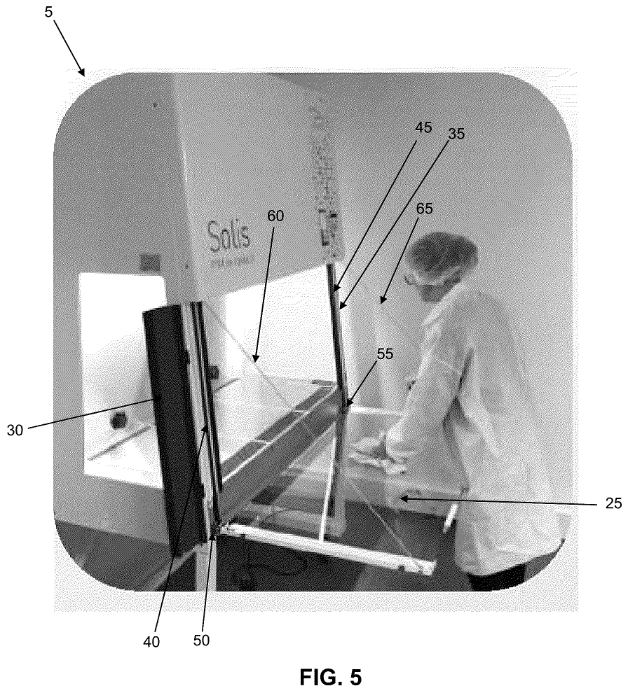

In one preferred form of the invention, and looking now at FIG. 5, safety cabinet 5 comprises a pair of shutters 30, 35 disposed on either side of opening 20. Shutters 30, 35 are hingedly mounted to housing 10 so as to permit shutters 30, 35 to be selectively swung sideboard so as to permit sash 25 to be swung outboard in order to permit cleaning of the inside surface of sash 25, as will hereinafter be discussed in further detail.

More particularly, and still looking at FIG. 5, with this form of the present invention, sash 25 is mounted to a pair of sliders 40, 45 which are, in turn, slidably mounted to housing 10. Sash 25 is preferably mounted to sliders 40, 45 via a pair of hinges 50, 55, respectively. With shutters 30, 35 in their closed position (i.e., the position shown in FIG. 1), sash 25 is able to be selectively moved vertically (i.e., by sliding sliders 40, 45 relative to housing 10), however, sash 25 cannot swing outboard on hinges 50, 55 because shutters 30, 35 prevent sash 25 from being moved away from sliders 40, 45. However, when shutters 30, 35 are in their sideboard open position (i.e., the position shown in FIG. 5), sash 25 can be selectively rotated outboard on hinges 50, 55, whereby to permit cleaning of the interior surface (i.e., the surface facing workspace 15) of sash 25. In one preferred form of the invention, a pair of retractable cable stays 60, 65 are provided in order to prevent damage to sash 25 when sash 25 is rotated outboard on hinges 50, 55. If desired, sliders 40, 45 or stays 60, 65 may comprise sensors (not shown) configured to transmit data to computer 95 indicative of the position of sash 25 relative to opening 20.

### Novel Lighting To Indicate Status Of Safety Cabinet

Looking now at FIG. 1, in another embodiment of the invention, if desired, novel safety cabinet 5 may comprise one or more visual indicators 140 (e.g., LED lights) for indicating the status of the safety cabinet.

By way of example but not limitation, safety cabinet 5 may comprise a plurality of visual indicators 140 mounted to shutters 30, 35 so as to be disposed in the general visual area of a technician working with safety cabinet 5 or in the vicinity thereof. Visual indicators 140 may be configured to indicate a status of safety cabinet 5.

In a preferred form of the invention, visual indicators 140 are configured to indicate a status of the position of sash 25. More particularly, with this form of the invention, when sash 25 is in a partially-open condition, visual indicators 140 are configured to turn on (e.g., to emit a red light) to visually indicate that safety cabinet 5 is not in a usable condition. It will also be appreciated that, if desired, visual indicators 140 may be configured to turn on (e.g., to emit a red light, to flash, etc.) when sash 25 has been open longer than a predetermined period of time (e.g., five minutes, etc.). Thus, if sash 25 is not properly closed, visual indicators 140 may turn on and/or flash, thereby providing a visual warning that safety cabinet 5 is not in condition for use, which visual warning can be appreciated at a distance (e.g., across a room) and help draw attention to a potentially unsafe condition so that it can be rectified. Alternatively and/or additionally, if desired, visual indicators 140 may be configured to turn on (e.g., to emit a red light, to flash, etc.) if sash 25 is positioned at an unsafe location (e.g., a position which exposes too much of workspace 15 as determined by the manufacturer of safety cabinet 5).

### Novel Camera System For Identifying

### Chemicals/Microoganisms/Materials

### Disposed In Workspace

In another form of the invention, and looking now at FIG. 1, if desired, safety cabinet 5 may comprise an internally-directed camera 150 connected to computer 95, which is configured to monitor workspace 15 and/or the area directly in front of sash 25 in order to identify chemicals/microorganisms/materials that are passed through opening 20 into workspace 15. Alternatively and/or additionally, if desired, externally-directed camera 102 may also be configured to monitor the area directly in front of sash 25 in order to identify chemicals/microorganisms/materials that are passed through opening 20 into workspace 15.

More particularly, with this form of the invention, camera 150 (and/or camera 102) and computer 95 are appropriately programmed to recognize labels (e.g., stickers placed on chemical bottles, biological sample bottles, etc.) in order to identify the substance that is being passed through opening 20 into workspace 15. By way of example but not limitation, computer 95 may be programmed with appropriate software to use image recognition analysis to isolate and identify labels on materials/microorganisms/chemicals placed into workspace 15. It will be appreciated that where microorganisms are to be identified by computer 95, camera 150 (and/or camera 102) are configured to view a label indicating the microorganism which is in the container containing the microorganism (e.g., the label on a petri dish, the label on a slant tube, the label on an Erlenmeyer flask, the label on a multi-well culture dish, etc.). It will be appreciated that, once computer 95 has identified the materials/chemicals disposed in workspace 15, computer 95 may be programmed to compare the identified materials/microorganisms/chemicals against a database in order to determine whether safety cabinet 5 is appropriately configured (e.g., running with the proper filtration apparatus installed, the correct fan speed, etc.) to handle the particular materials/chemicals disposed in workspace 15.

If desired, computer 95 may be configured to emit a visual alert if computer 95 determines that safety cabinet 5 is not properly configured for the particular materials/chemicals disposed in workspace 15. By way of example but not limitation, if computer 95 determines that safety cabinet 5 is not properly configured for the particular materials/chemicals disposed in workspace 15, computer 95 may illuminate one or more indicators 140.

### Modifications Of The Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. Apparatus for effecting safe handling of biological and/or chemical materials, the apparatus comprising:
a housing enclosing a workspace, wherein the housing comprises an opening for accessing the workspace;
a sash mounted to the housing, the sash being configured to move between a closed position in which the sash covers the opening of the workspace and an open position in which the sash does not cover the opening of the workspace;
a ventilation system disposed in the housing for drawing air out of the workspace;
a motor for moving the sash between the open position and the closed position;
an external power source for operating at least one of the ventilation system and the motor; and
a secondary power source for operating at least one of the ventilation system and the motor when the external power source cannot deliver power to operate at least one of the ventilation system and the motor.

2. Apparatus according to claim 1 wherein the secondary power source comprises a battery.

3. Apparatus according to claim 1 wherein the apparatus comprises at least one light for illuminating the workspace.

4. Apparatus according to claim 3 wherein the secondary power source is configured to illuminate the at least one light when the external power source cannot deliver power to operate at least one of the ventilation system and the motor.

5. Apparatus according to claim 1 wherein the motor is configured to move the sash to the closed position using power from the secondary power source when the external power source cannot deliver power to operate at least one of the ventilation system and the motor.

6. Apparatus according to claim 1 wherein the sash is pivotally connected to the housing such that the sash is selectively rotatable between the closed position and the open position.

7. Apparatus according to claim 1 wherein the ventilation system comprises a filter for filtering the air drawn from the workspace.

8. Apparatus according to claim 1 wherein the apparatus further comprises a computer configured to operate at least one of the motor and the ventilation system.

9. Apparatus for effecting safe handling of biological and/or chemical materials, the apparatus comprising:
a housing enclosing a workspace, wherein the housing comprises an opening for accessing the workspace;
a sash mounted to the housing, the sash configured to move between a closed position in which the sash covers the opening of the workspace and an open position in which the sash does not cover the opening of the workspace;
a ventilation system disposed in the housing for drawing air out of the workspace;
a motor for moving the sash between the open position and the closed position; and
a command module configured to operate the motor for moving the sash.

10. Apparatus according to claim 9 further comprising a microphone, and further wherein the command module is configured to analyze audio data captured by the microphone, whereby to permit verbal commands to be used to control operation of the motor so as to permit voice-activated movement of the sash.

11. Apparatus according to claim 9 wherein the apparatus further comprises at least one camera, and further wherein the command module is configured to analyze image data captured by the at least one camera, whereby to permit hand gestures to be used to control operation of the motor so as to permit hand gesture-activated movement of the sash.

12. Apparatus according to claim 9 wherein the apparatus further comprises at least one remote control wirelessly connected to the command module, and further wherein the command module is configured to receive data from the at least one remote control, whereby to permit remote control operation of the motor so as to permit remote control-activated movement of the sash.

13. Apparatus for effecting safe handling of biological and/or chemical materials, the apparatus comprising:
a housing enclosing a workspace, wherein the housing comprises an opening for accessing the workspace; and
a decontamination system configured to selectively emit a decontamination agent into the workspace so as to decontaminate the workspace, the decontamination system comprising:
a reservoir comprising a decontamination agent; and
a decontamination array fluidically connected to the reservoir, the decontamination array comprising at least one dispersion head configured to emit the decontamination agent into the workspace.

14. Apparatus according to claim 13 further comprising a sash mounted to the house, the sash configured to move between a closed position in which the sash covers the opening of the workspace and an open position in which the sash does not cover the opening of the workspace, wherein the sash comprises an inner surface facing the workspace and an outer surface facing away from the workspace, wherein the sash is pivotally mounted to the housing such that the sash can be selectively pivoted downward, whereby to permit cleaning of the inner surface of the sash.

15. Apparatus according to claim 14 further comprising at least one cable for selectively moving the sash between the open position and the closed position.

16. Apparatus according to claim 14 further comprising at least one hinge for pivoting the sash downward.

17. Apparatus according to claim 16 further comprising at least one retractable cable stay for connecting the sash to the housing.

18. Apparatus for effecting safe handling of biological and/or chemical materials, the apparatus comprising:
a housing enclosing a workspace, wherein the housing comprises an opening for accessing the workspace;
a sash mounted to the housing, the sash being configured to move between a closed position in which the sash covers the opening and an open position in which the sash does not cover the opening;
at least one sensor for detecting the position of the sash relative to the opening; and
at least one visual indicator mounted to the housing;
wherein the at least one visual indicator is configured to emit a visual signal indicating the position of the sash.

19. Apparatus according to claim 18 wherein the visual signal is emitted when the sash does not properly close the opening.

20. Apparatus according to claim 18 wherein the visual signal comprises at least one from the group consisting of a solid light and a flashing light.

21. Apparatus according to claim 18 wherein the sensor is disposed on a cable mounting the sash to the housing.

22. Apparatus for effecting safe handling of biological and/or chemical materials, the apparatus comprising:
a housing enclosing a workspace, wherein the housing comprises an opening for accessing the workspace;
a sash mounted to the housing, the sash being configured to move between a closed position in which the sash covers the opening and an open position in which the sash does not cover the opening;
a least one camera mounted to the housing such that the at least one camera can obtain image data of at least one of the workspace and the opening; and
a computer, wherein the computer is configured to analyze image data obtained by the at least one camera in order to identify materials placed in the workspace.

23. Apparatus according to claim 22 wherein the apparatus further comprises at least one visual indicator mounted to the housing.

24. Apparatus according to claim 23 wherein the at least one visual indicator is illuminated when the material in the workspace is identified as not appropriate for the workspace.

25. Apparatus according to claim 22 further comprising a ventilation system for drawing air out of the workspace, wherein the ventilation system is configured to turn on when the material in the workspace is identified as needing ventilation.

26. A method for effecting safe handling of biological and/or chemical materials, the method comprising:
providing apparatus comprising:
a housing enclosing a workspace, wherein the housing comprises an opening for accessing the workspace;
a sash mounted to the housing, the sash being configured to move between a closed position in which the sash covers the opening of the workspace and an open position in which the sash does not cover the opening of the workspace;
a ventilation system disposed in the housing for drawing air out of the workspace;
a motor for moving the sash between the open position and the closed position;
an external power source for operating at least one of the ventilation system and the motor; and
a secondary power source for operating at least one of the ventilation system and the motor when the external power source cannot deliver power to operate at least one of the ventilation system and the motor; and
using power from the secondary power source to power at least one of the ventilation system and the motor when the external power source cannot deliver power to operate at least one of the ventilation system and the motor.

27. A method for effecting safe handling of biological and/or chemical materials, the method comprising:
providing apparatus comprising:
a housing enclosing a workspace, wherein the housing comprises an opening for accessing the workspace;
a sash mounted to the housing, the sash configured to move between a closed position in which the sash covers the opening of the workspace and an open position in which the sash does not cover the opening of the workspace;
a ventilation system disposed in the housing for drawing air out of the workspace;
a motor for moving the sash between the open position and the closed position; and
a command module configured to operate the motor for moving the sash; and
using the command module to move the sash between the open position and the closed position.

28. A method for effecting safe handling of biological and/or chemical materials, the method comprising:
providing apparatus comprising:
a housing enclosing a workspace, wherein the housing comprises an opening for accessing the workspace; and
a decontamination system configured to selectively emit a decontamination agent into the workspace so as to decontaminate the workspace, the decontamination system comprising:
a reservoir comprising a decontamination agent; and
a decontamination array fluidically connected to the reservoir, the decontamination array comprising at least one dispersion head configured to emit the decontamination agent into the workspace; and
emitting the decontamination agent into the workspace so as to decontaminate the workspace.

29. A method for effecting safe handling of biological and/or chemical materials, the method comprising:
providing apparatus comprising:
a housing enclosing a workspace, wherein the housing comprises an opening for accessing the workspace;
a sash mounted to the housing, the sash being configured to move between a closed position in which the sash covers the opening and an open position in which the sash does not cover the opening;
at least one sensor for detecting the position of the sash relative to the opening; and
at least one visual indicator mounted to the housing;
wherein the at least one visual indicator is configured to emit a visual signal indicating the position of the sash; and
emitting a visual signal to indicate the position of the sash.

30. A method for effecting safe handling of biological and/or chemical materials, the method comprising:
providing apparatus comprising:
a housing enclosing a workspace, wherein the housing comprises an opening for accessing the workspace;
a sash mounted to the housing, the sash being configured to move between a closed position in which the sash covers the opening and an open position in which the sash does not cover the opening;
a least one camera mounted to the housing such that the at least one camera can obtain image data of at least one of the workspace and the opening; and
a computer, wherein the computer is configured to analyze image data obtained by the at least one camera in order to identify materials placed in the workspace; and
identifying materials placed in the workspace.

31. Apparatus according to claim 9 wherein the sash is pivotally connected to the housing such that the sash is selectively rotatable between the closed position and the open position.

32. Apparatus according to claim 13 further comprising:
a sash mounted to the housing, the sash being configured to move between a closed position in which the sash covers the opening of the workspace and an open position in which the sash does not cover the opening of the workspace;
wherein the sash is pivotally connected to the housing such that the sash is selectively rotatable between the closed position and the open position.

33. Apparatus according to claim 18 wherein the sash is pivotally connected to the housing such that the sash is selectively rotatable between the closed position and the open position.

34. Apparatus according to claim 22 wherein the sash is pivotally connected to the housing such that the sash is selectively rotatable between the closed position and the open position.
